(19) United States
(12) Patent Application Publication
(10) Pub. No.: US 2017/0308736 A1
(43) Pub. Date: Oct. 26, 2017

(54) THREE DIMENSIONAL OBJECT RECOGNITION

(71) Applicant: Hewlett-Packard Development Company, L.P., Houston, TX (US)

(72) Inventors: Divya Sharma, Palo Alto, CA (US); Kar-Han Tan, Sunnyvale, CA (US); Daniel R Tretter, San Jose, CA (US)

(73) Assignee: Hewlett-Packard Development Company, L.P., Houston, TX (US)

(21) Appl. No.: 15/518,412

(22) PCT Filed: Oct. 28, 2014
(86) PCT No.: PCT/US2014/062580

§ 371 Date: Apr. 11, 2017

(51) Int. Cl. G06K 9/00; G06T 7/11; G06K 9/62; G06K 9/46

(52) U.S. Cl. CPC G06K 9/00214; G06K 9/6218; G06K 9/4652; G06K 9/6211; G06T 7/11; G06T 2200/04; G06T 2207/10024; G06T 2207/10028

(57) ABSTRACT

A methods and system for recognizing a three dimensional object on a base are disclosed. A three dimensional image of the object is received as a three-dimensional point cloud having depth data and color data. The base is removed from the three dimensional point cloud to generate a two-dimensional image representing the object. The two-dimensional image is segmented to determine object boundaries of a detected object. Color data from the object is applied to refine segmentation and match the detected object to a reference object data.

### BACKGROUND

A visual sensor captures visual data associated with an image of an object in a field of view. Such data can include data regarding the color of the object, data regarding the depth of the object, and other data regarding the image. A cluster of visual sensors can be applied to certain application. Visual data captured by the sensors can be combined and processed to perform a task of an application.

### BRIEF DESCRIPTION OF THE DRAWINGS

FIG. 1 is a block diagram illustrating an example system of the present disclosure.

FIG. 2 is a schematic diagram of an example of the system of FIG. 1.

FIG. 3 is a block diagram illustrating an example method that can be performed with the system of FIG. 1.

FIG. 4 is a block diagram illustrating an example system constructed in accordance with the system of FIG. 1.

FIG. 5 is a block diagram illustrating an example computer system that can be used to implement the system of FIG. 1 and perform the methods of FIGS. 3 and 4.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

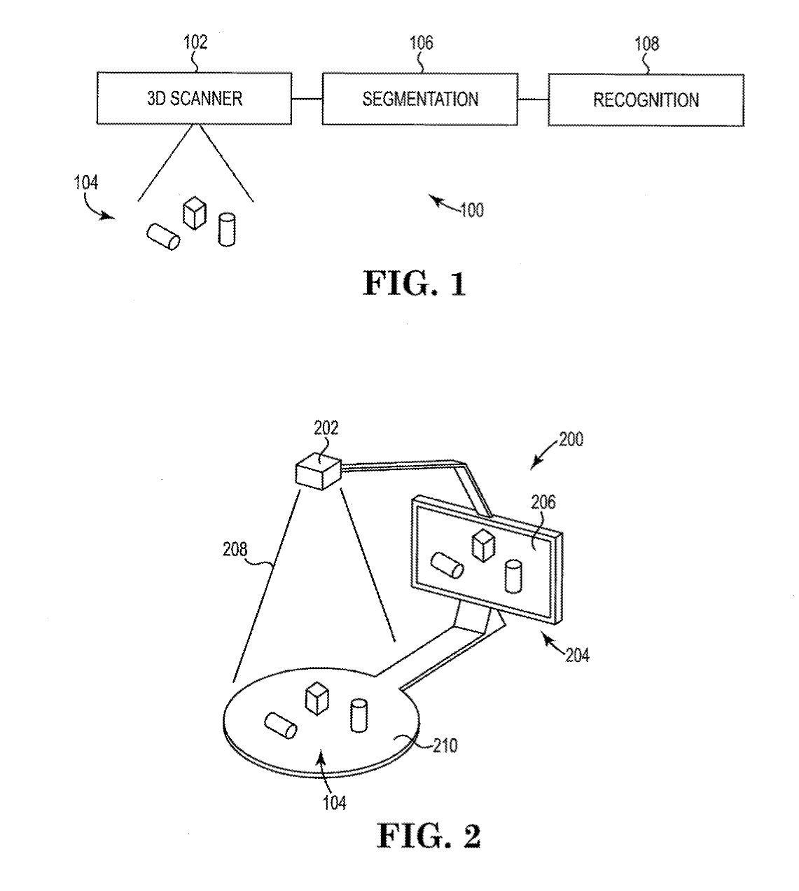

The following disclosure relates to an improved method and system to segment and recognize objects in a three dimensional image. FIG. 1 illustrates an example method 100 that can be applied as a user application or system to robustly and accurately recognize objects in a 3D image. A 3D scanner 102 is used to generate one or more images of one or more real objects 104 placed in the field of view. In one example, the 3D scanner can include color sensors and depth sensors each generating an image of an object. In the case of multiple sensors, images from each of the sensors are calibrated and then merged together to form a corrected 3D image to be stored as a point cloud. A point cloud is a set of data points in some coordinate system stored as a data file. In a 3D coordinate system, x, y, and z coordinates usually defines these points, and often are intended to represent the external surface of the real object 104. The 3D scanner 102 measures a large number of points on an object's surface, and outputs the point cloud as a data file having spatial information of the object. The point cloud represents the set of points that the device has measured. Segmentation 106 applies algorithms to the point cloud to detect the boundaries of the object or objects in the image. Recognition 108 includes matching the features of the segmented objects to a set of known features, such as by comparing the data regarding the segmented object to predefined data in a tangible storage medium such as a computer memory.

FIG. 2 illustrates a particular example system 200 applying method 100 where like parts of FIG. 1 have like reference numerals in FIG. 2. System 200 includes sensor cluster module 202 used to scan the objects 104 and input data into a computer 204 running an object detection application. In the example, the computer 204 includes a display 206 to render images and/or interfaces of the object detection application. The sensor cluster module 202 includes a field of view 208. The objects 104 are placed a generally planar surface, such as a tabletop, within the field of view 208 from the sensor cluster module 202. Optionally, the system 200 can include a generally planar platform 210 within the field of view 208 receives the object 104. In one example, the platform 210 is stationary, but it is contemplated that the platform 210 can include a turntable that can rotate the object 104 about an axis with respect to the sensor cluster module 202. System 200 shows an example where objects 104 are placed on a generally planar surface in a field of view 208 of an overhead sensor cluster module 202.

Object 104 placed within the field of view 208 can be scanned and input one or more times. A turntable on platform 210 can rotate the object 104 about the z-axis with respect to the sensor cluster module 202 when multiple views of the objects 104 is input. In some examples, multiple sensor cluster modules 202 can be used, or the sensor cluster module 202 can provide a scan of the object and projection of the image without having to move the object 104 and while the object is in any or most orientations with respect to the sensor cluster module 202.

Sensor cluster module 202 can include a set of heterogeneous visual sensors to capture visual data of an object in a field of view 208. In one example, the module 202 includes one or more depth sensors and one or more color sensors. A depth sensor is a visual sensor used to capture depth data of the object. In one example, depth generally refers to the distance of the object from the depth sensor. Depth data can be developed for each pixel of each depth sensor, and the depth data is used to create a 3D representation of the object. Generally, a depth sensor is relatively robust against effects due to a change in light, shadow, color, or a dynamic background. A color sensor is a visual sensor used to collect color data in a visible color space, such as a red-green-blue (RGB) color space or other color space, which can be used to detect the colors of the object 104. In one example, a depth sensor and a color sensor can be included a depth camera and color camera, respectively. In another example, the depth sensor and color sensor can be combined in a color/depth camera. Generally, the depth sensor and color sensor have overlapping fields of view indicated in the example as filed of view 208. In one example, a sensor cluster module 108 can include multiple sets of spaced-apart heterogeneous visual sensors that can capture depth and color data from various different angles of the object 104.

In one example, the sensor cluster module 202 can capture the depth and color data as a snapshot scan to create a 3D image frame. An image frame refers to a collection of visual data at particular point in time. In another example, the sensor cluster module can capture the depth and color data as a continuous scan as a series of image frames over the course of time. In one example, a continuous scan can include image frames staggered over the course of time in periodic or aperiodic intervals of time. For example, the sensor cluster module 202 can be used to detect the object and then later to detect the location and orientation of the object.

The 3D images are stored as point cloud data files in a computer memory either locally or remotely from the sensor cluster module 202 or computer 204. A user application, such as an object recognition application having tools such as point cloud libraries, can access the data files. Point cloud libraries with object recognition applications typically include 3D object recognition algorithms applied to 3D point clouds. The complexity in applying these algorithms increases exponentially as the size, or amount of data points, in the point cloud increases. Accordingly, 3D object recognition algorithms applied to large data files become slow and inefficient. Further, the 3D object recognition algorithms are not well suited for 3D scanners having visual sensors of different resolutions. In such circumstances, a developer will tune the algorithms using a complicated process in order to recognize objects created with sensors of different resolutions. Still further, these algorithms are built around random sampling of the data in the point cloud and data fitting and are not particularly accurate. For example, multiple applications of the 3D object recognition algorithms often do not generate the same result.

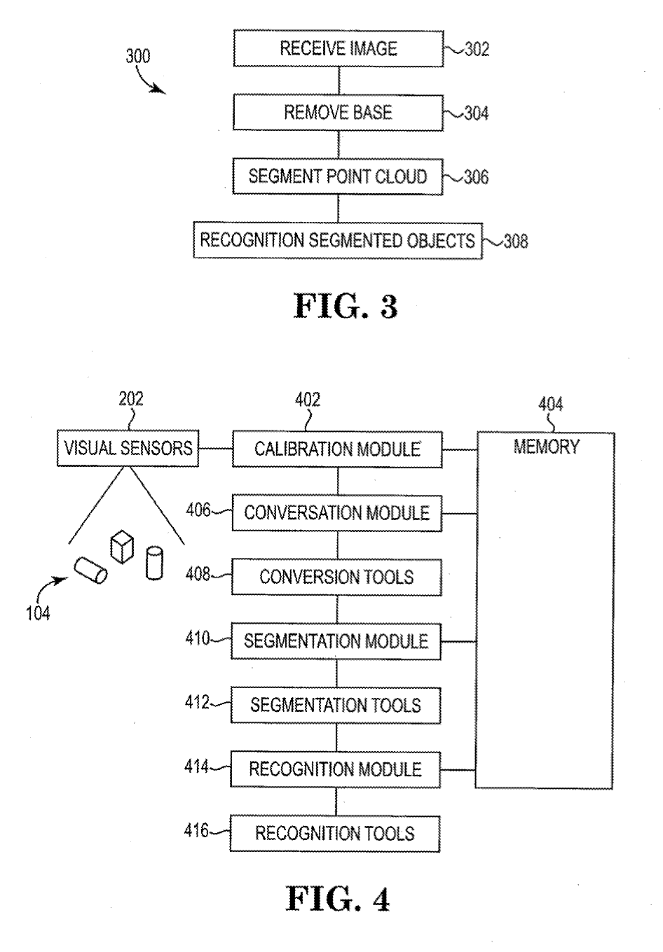

FIG. 3 illustrates an example of a robust and efficient method 300 to quickly segment and recognize objects 104 placed on a generally planar base in the field of view 208 of a sensor cluster module 202. The texture of the objects 104, stored as two-dimensional data, is analyzed to recognize the objects. Segmentation and recognition can be performed real time without the inefficiencies of bloated 3D point cloud processing. Processing in the 2D space allows for the use of more sophisticated and accurate feature recognition algorithms. Merging this information with 3D cues improves the accuracy and robustness of segmentation and recognition. In one example, method 300 can be implemented as a set of machine readable instructions on a computer readable medium.

A 3D image of an object 104 is received at 302. When an image taken with color sensor and an image taken with the depth sensor are used to create the 3D image, image information for each sensor is often calibrated to create an accurate 3D point cloud of the object 104 including coordinates such as (x, y, z). This point cloud includes 3D images of the objects as well as the generally planar base on which the objects are placed. In some examples, the received 3D image may include unwanted outlier data that can be removed with tools such as a pass-through filter. Many, if not all, of the points that do not fall in the permissible depth range from camera are removed.

The base, or generally planar surface, on which the object 104 is placed, is removed from the point cloud at 304. In one example, a plane fitting technique is used to remove the base from the point cloud. One such plane fitting technique can be found in tools applying RANSAC (Random sample consensus), which is an iterative method to estimate parameters of a mathematical model from a set of observed data that contains outliers. In this case, the outliers can be the images of the objects 104 and the inliers can be the image of the planar base. Accordingly, depending on the sophistication of the plane fitting tool, the base on which the object is placed can deviate from a true plane. In typical cases, plane-fitting tools are able to detect the base if it is generally planar to the naked eye. Other plane-fitting techniques can be used.

In this example, the 3D data from the point cloud is used to remove the planar surface from the image. The point cloud with the base removed can be used as a mask to detect the object 104 in the image. The mask includes data points representing the object 104. Once the base has been subtracted from the image, the 3D point cloud is projected onto a 2D plane having depth information but using much less storage space than the 3D point cloud.

The 2D data developed at 304 is suitable for segmentation at 306 with more sophisticated techniques than those typically used on a 3D point cloud. In one example, the 2D planar image of the object is subjected to a contour analysis for segmentation. An example of contour analysis includes a topological structural analysis of digitized binary images using border following technique, which is available in OpenCV available under a form of permissive free software license. OpenCV, or Open Source Computer Vision, is a cross-platform library of programming functions generally directed at real-time computer vision. Another technique can be Moore's Neighbour tracing algorithm to find the boundary of object from processed 2D image data. Segmentation 306 can also distinguish multiple objects in the 2D image data from each other. The segmented object image is given a label, which may be different than other objects in the 2D image data, and the label is a representation of the object in 3D space. A label mask is generated containing all the objects assigned a label. Further processing can be applied to remove unexpected or ghost contours, if any appear in the 2D image data.

The label mask can be applied to recognize the object 104 at 308. In one example, corrected depth data is used to find the object's height, orientation, or other characteristics of a 3D object. This way without processing or clustering the 3D point cloud, additional characteristics can be determined from the 2D image data to refine and improve the segmentation from the color sensor.

The color data corresponding to each label is extracted and used in feature matching for object recognition. In one example, the color data can be compared to data regarding to known objects, which can be retrieved from a storage device, to determine a match. Color data can correspond with intensity data, and several sophisticated algorithms are available to match objects based on features derived from the intensity data. Accordingly, the recognition is more robust than randomized algorithms.

FIG. 4 illustrates an example system 400 for applying method 300. In one example, the system 400 includes the sensor cluster module 202 to generate color and depth images of the object 104 or objects on a base, such as a generally planar surface. The images from the sensor are provided to a calibration model 402 to generate a 3D point cloud to be stored as a data file in a tangible computer memory device 404. A conversion module 406 receives the 3D data file and applies conversion tools 408, such as RANSAC, to remove the base from the 3D data file and create a 2D image data of the object with an approximate segmentation providing label of each segmented object along with other 3D characteristics such as height, which can be stored as a data file in the memory 404.

A segmentation module 410 can receive the data file of the 2D representation of the object and applies segmentation tools 412 to determine the boundaries of the object image. As described above, the segmentation tools 412 can include contour analysis on the 2D image data, which is faster and more accurate than techniques to determine images in 3D representations. The segmented object images can be given a label that represents the object in a 3D space.

A recognition module 414 can also receive the data file of the 2D image data. The recognition module 414 can apply recognition tools 416 to the data file of the 2D image data to determine the height, orientation and other characteristics of the object 104. The color data in the 2D image that corresponds to each label is extracted and used in feature matching for recognizing object. In one example, the color data can be compared to data regarding to known objects, which can be retrieved from a storage device, to determine a match.

No current, generally available solution that merges depth data and color data performs a faster and more accurate 3D object segmentation and recognition than that describe above. Example method 300 and system 400 provide a real time implementation that provides faster, more accurate results consuming less memory for segmenting and recognizing 3D data than using a 3D point cloud.

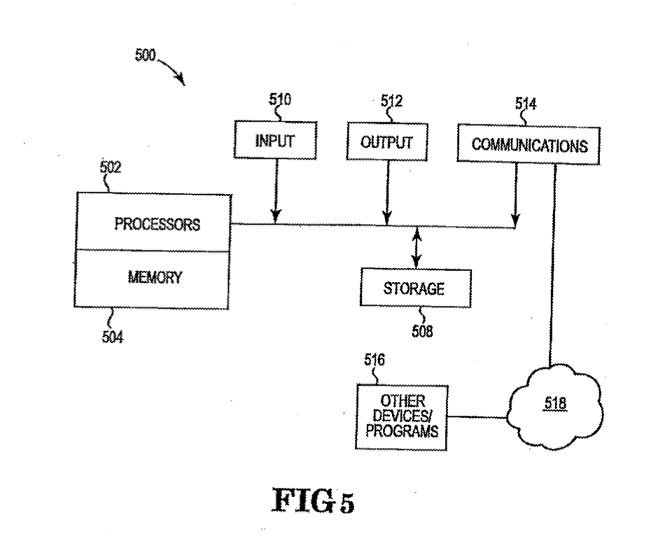

FIG. 5 illustrates an example computer system that can be employed in an operating environment and used to host or run a computer application implementing an example method 300 as included on one or more computer readable storage mediums storing computer executable instructions for controlling the computer system, such as a computing device, to perform a process. In one example, the computer system of FIG. 5 can be used to implement the modules and its associated tools set forth in system 400.

The exemplary computer system of FIG. 5 includes a computing device, such as computing device 500. Computing device 500 typically includes one or more processors 502 and memory 504. The processors 502 may include two or more processing cores on a chip or two or more processor chips. In some examples, the computing device 500 can also have one or more additional processing or specialized processors (not shown), such as a graphics processor for general-purpose computing on graphics processor units, to perform processing functions offloaded from the processor 502. Memory 504 may be arranged in a hierarchy and may include one or more levels of cache. Memory 504 may be volatile (such as random access memory (RAM)), nonvolatile (such as read only memory (ROM), flash memory, etc.), or some combination of the two. The computing device 500 can take one or more of several forms. Such forms include a tablet, a personal computer, a workstation, a server, a handheld device, a consumer electronic device (such as a video game console or a digital video recorder), or other, and can be a stand-alone device or configured as part of a computer network, computer cluster, cloud services infrastructure, or other.

Computing device 500 may also include additional storage 508. Storage 508 may be removable and/or non-removable and can include magnetic or optical disks or solid-state memory, or flash storage devices. Computer storage media includes volatile and nonvolatile, removable and non-removable media implemented in any suitable method or technology for storage of information such as computer readable instructions, data structures, program modules or other data. A propagating signal by itself does not qualify as storage media.

Computing device 500 often includes one or more input and/or output connections, such as USB connections, display ports, proprietary connections, and others to connect to various devices to receive and/or provide inputs and outputs. Input devices 510 may include devices such as keyboard, pointing device (e.g., mouse), pen, voice input device, touch input device, or other. Output devices 512 may include devices such as a display, speakers, printer, or the like. Computing device 500 often includes one or more communication connections 514 that allow computing device 500 to communicate with other computers/applications 516. Example communication connections can include, but are not limited to, an Ethernet interface, a wireless interface, a bus interface, a storage area network interface, a proprietary interface. The communication connections can be used to couple the computing device 500 to a computer network 518, which is a collection of computing devices and possibly other devices interconnected by communications channels that facilitate communications and allows sharing of resources and information among interconnected devices. Examples of computer networks include a local area network, a wide area network, the Internet, or other network.

Computing device 500 can be configured to run an operating system software program and one or more computer applications, which make up a system platform. A computer application configured to execute on the computing device 500 is typically provided as set of instructions written in a programming language. A computer application configured to execute on the computing device 500 includes at least one computing process (or computing task), which is an executing program. Each computing process provides the computing resources to execute the program.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A processor-implemented method for recognizing a three dimensional object on a base, comprising:
receiving a three dimensional image of the object as a three dimensional point cloud having spatial information of the object;
removing the base from the three dimensional point cloud to generate a two dimensional image representing the object;
segmenting the two dimensional image to determine object boundaries; and
applying color data from the object to refine segmentation and match the detected object to a reference object data.

2. The method of claim 1 comprising calibrating the color data and depth data to generate the three dimensional image of the object.

3. The method of claim 1 wherein removing the base includes applying an iterative process to estimate parameters of a model from a set of observed data that contains outliers that represent the object.

4. The method of claim 1 wherein the base is generally planar.

5. The method of claim 1 wherein the two-dimensional point cloud includes a mask including data representing the object.

6. The method of claim 1 wherein the segmenting includes distinguishing multiple objects in the point cloud from each other.

7. The method of claim 1 wherein the segmenting includes attaching a label to the detected object.

8. The method of claim wherein applying depth data includes determining the orientation of the detected object.

9. A computer readable medium for storing computer executable instructions for controlling a computing device having a processor and memory to perform a method for recognizing a three dimensional object on a base, the method comprising:
receiving a three dimensional image of the object as a three dimensional point cloud as data file in the memory, the three dimensional point cloud having depth data;
removing, with the processor, the base from the three dimensional point cloud to generate a two dimensional image in the memory representing the object;
segmenting, with the processor, the two dimensional image to determine object boundaries;
applying, with the processor, the depth data to determine height of the object; and
applying, with the processor, color data from the image to match the object to a reference object data.

10. The computer readable medium of claim 9 wherein removing the base is performed with a plane fitting technique.

11. The computer readable medium of claim 9 wherein removing the segmenting is performed with a contour analysis algorithm

12. A system for recognizing a three dimensional object on a base, comprising:
a module for receiving a first data file representing a three dimensional image of the object as a three dimensional point cloud having depth data;
a conversion module operating on a processor and configured to remove the base from the three dimensional point cloud into a second data file representing a two dimensional image of the object to be stored in a memory device;
a segmenting module to determine object boundaries in the two dimensional image; and
a detection module operating on the processor and configured to apply the depth data to determine height of the object, and configured to apply color data from the image to match the object to a reference object data.

13. The system of claim 12 comprising a color sensor configured to generate a color image having color data and a depth sensor configured to generate a depth image having depth data.

14. The system of claim 13 wherein the color sensor and depth sensor are configured as a color/depth camera.

15. The system of claim 13 wherein the color/depth camera includes a field of view and comprising a turntable configured as the base and disposed in the field of view.
